(19) United States
(12) Patent Application Publication
(10) Pub. No.: US 2015/0032854 A1
(43) Pub. Date: Jan. 29, 2015

(54) SYSTEM AND METHOD FOR NETWORK-ASSISTED ADAPTIVE STREAMING

(71) Applicant: Futurewei Technologies Inc., Plano, TX (US)

(72) Inventors: Xin Wang, Rancho Palos Verdes, CA (US); Yuqun Fan, Shenzhen (CN); Lei Zhou, Shenzhen (CN); Xin Liu, Shenzhen (CN); Shaobo Zhang, Shenzhen (CN); Yongliang Liu, Beijing (CN)

(21) Appl. No.: 14/340,465

(22) Filed: Jul. 24, 2014

Related U.S. Application Data
(60) Provisional application No. 61/858,044, filed on Jul. 24, 2013.

(51) Int. Cl. H04L 29/06; H04L 12/911; H04L 12/24

(52) U.S. Cl. CPC H04L 65/60; H04L 41/50; H04L 47/70
USPC 709/219

(57) ABSTRACT

A system, method and device are configured to guarantee bandwidth to adaptive streaming clients through negotiation with a network unit to achieve better quality of services in adaptive streaming that utilizes network bandwidth conditions more accurately than based on client estimations.

### CROSS REFERENCE TO RELATED APPLICATIONS

This application claims priority under 35 USC 119(e) to U.S. Provisional Application Ser. No. 61/858,044, filed on Jul. 24, 2013, which is incorporated herein by reference.

### TECHNICAL FIELD

The present invention relates generally to communication networks and, more particularly, to network-assisted adaptive streaming.

### BACKGROUND

Many television and movie viewers now desire on-demand access to video and other media content. As a first example, a television viewer may desire to watch a television show that he or she missed during the show's regular air time on television. The viewer may download the show on demand over the Internet via a web browser or other application on a notebook computer, tablet computer, desktop computer, mobile telephone or other device, then view that show in the browser or other application. In other examples, a viewer may download a movie on demand or may participate in a videoconference with other viewers.

Dynamic Adaptive Streaming over Hypertext Transfer Protocol (DASH) is a standard developed to provide such media content and is partially described in International Organization for Standardization (ISO)/International Electrotechnical Commission (IEC) 23009-1, First Edition, 2012 (“23009-1”), which is incorporated herein by reference in its entirety. In addition, ISO/IEC 23009-1, Technical Corrigendum 1, 2013 is incorporated herein by reference in its entirety. In DASH, there are two main devices: the Hypertext Transfer Protocol (HTTP) server(s) that provide the content and the DASH client that downloads the content and is associated with the viewer (or user). Currently, DASH leaves control with the client, which can request content using the HTTP protocol.

DASH functions to partition media content (e.g., a video of potentially many minutes or hours of duration) into a sequence of smaller media segments—each segment being of a short interval of playback time. Each segment is made available to a DASH client in multiple alternatives—each at a different bit rate. As the content is played, the DASH client automatically selects a next segment (to be played) from its alternatives. This selection is based on various factors, including current network conditions. The resulting benefit is that the DASH client can adapt to changing network conditions and play back content at a highest level of quality without stalls or rebuffering events.

DASH clients can be any devices with DASH and media content playing functionality having wireless and/or wireline connectivity. For example, a DASH client may be a desktop or laptop computer, smartphone, tablet, set-top box, televisions connected to the internet, and the like, etc.

Now referring to FIG. 1, there is illustrated a DASH standards-based adaptive media streaming model where portions of media streams and media segments are requested by DASH client devices 10a-10n using HTTP and are delivered by one or more DASH (HTTP) servers 12 via a network 11 (including the internet). As will be appreciated, the telecommunications network 11 may be any suitable network (or combinations of networks) enabling transmission of media content using HTTP. As an example only, the telecommunications network 11 is shown as including various telecommunications resources and infrastructures, such as network address translators and/or firewalls 18, caches 14 and Content Distribution Networks (CDNs) 16. These resources support on-demand, live streaming and time-shift applications and services to network-connected devices, such as the DASH clients 10a-10n.

Each DASH client 10 can dynamically adapt the bitrate of the requested media content/stream to changes in network conditions, by switching between different versions of the same media segment encoded at different bitrates.

As illustrated in FIG. 2, DASH is based on a hierarchical data model described by a Media Presentation Description (MPD), which defines formats to announce resource identifiers for a collection of encoded and deliverable versions of media content. The MPD is an XML document that advertises the available media and provides information needed by the DASH client in order to select segments from a Representation, make adaptation decisions, and retrieve segments from their servers via the network. Media content is composed of single or multiple contiguous segments.

The MPD provides sufficient information for the DASH client to provide a streaming service to the user by requesting segments from an HTTP (DASH) server and de-multiplexing (when needed), decoding and rendering the received media segments. The MPD is completely independent of media segments and only identifies the properties needed to determine whether a Representation can be successfully played and its functional properties (e.g., whether segments start at random access points).

As further illustrated in FIG. 2, a media segment is the minimal individually addressable unit of content data. It is the entity that can be downloaded using a URL advertised via the MPD. One example of a media segment is a 4-second part of a live broadcast, which starts at playout time 0:42:38, ends at 0:42:42, and is available within a 3-minute time window. Another example could be a complete on-demand movie, which is available for the whole period the movie is licensed.

A Representation defines a single encoded version of the complete asset, or of a subset of its components. A typical Representation may be, for example, an ISO-BMFF containing unmultiplexed 2.5 Mbps 720p AVC video and separate ISO-BMFF Representations for 96 Kbps MPEG-4 AAC audio in different languages. Conversely, a single transport stream containing video, audio and subtitles can be a single multiplexed Representation. A combined structure is possible: video and English audio may be a single multiplexed Representation, while Spanish and Chinese audio tracks are separate unmultiplexed Representations.

Now turning to FIG. 3, there is shown a functional block diagram illustrating one of the conventional DASH clients 10 interconnected with an HTTP (DASH) server 12. No further description or explanation of the components and/or functionality of the conventional DASH client 10 and DASH server 12 are provided herein, other than as applicable to the disclosure and teachings herein.

To provide a smooth streaming experience, a DASH client may choose bitrate adaptation to changing network conditions and the adaptation strategy depends on bandwidth estimation. Currently, the bandwidth estimation is based on statistics of download history which means it only reflects the bandwidth in the past and is unable to accurately predict the bandwidth in the future.

In the case of congestion, different DASH clients compete for network resources through different adaptation strategies. Unfortunately, one client may get more network resources through a more aggressive adaptation strategy. The network has no ability to control adaptation strategies and provide different services to different users based on a network operator's preference. In addition, sufficient levels of streaming may not be guaranteed, for example, over wireless networks involving many clients with differing devices (e.g., different display sizes, manufacturers, etc.).

Therefore there is a need for systems, methods and devices for network-assisted adaptive streaming to facilitate bandwidth prediction more accurately for DASH clients to enable high quality streaming to a larger number of clients.

### SUMMARY

According to one embodiment, a network provides guaranteed bandwidth to DASH clients through negotiation to help estimate bandwidth conditions more accurately. A DASH client requests a guaranteed bandwidth based on a media presentation description. If the DASH client wants to request a media segment of certain bitrate, it first requests for the network to provide a guaranteed bandwidth based on the bitrate information before it makes a request for the media segment. Here, the guaranteed bandwidth can be a minimum bit rate.

In another embodiment, the network enforces bandwidth limits on users based on that user's subscription information from the network operator and/or service provider to provide different services to different users. A request for guaranteed bandwidth which exceeds the user's bandwidth limit is rejected by the network.

In yet another embodiment, the adaptation strategy of a DASH client may be based on a network's guaranteed bandwidth information instead of its own bandwidth detection. The network can provide different services to different users by enforcing bandwidth limits.

In a different embodiment a network unit (e.g., an eNodeB) has the functionality and capability to control spectrum resources and provide bandwidth guarantee to DASH clients since it is the last access point and/or bottleneck in a cellular environment.

In an embodiment, QoS information is exchanged between the DASH client, the network and the server to improve the client's quality of service when radio congestion is present.

In an embodiment, based on a user's subscription information/level (at the network operator and/or media service provider), the network operator or the service provider provides different quality of service to different users.

In one embodiment, there is provided a method for requesting media content in a dynamic adaptive media streaming system over a transmission network, according to a media presentation description (MPD) comprising MPD information identifying a plurality of media segments. The method includes generating and transmitting, by a user device, a request for a guaranteed bitrate/bandwidth rate (GBR) to the network and receiving a response authorizing a GBR for the user device. The user device selects, based on the authorized GBR and the MPD information, at least one of the plurality of media segments, generates and transmits a request to a content server identifying the selected at least one of the plurality of media segments, and receives from the content server the selected at least one of the plurality of media segments.

In another embodiment, there is provided an adaptive media streaming method in a network. The method includes authenticating and authorizing a bandwidth limit of a user based on subscription information of the user in a network; receiving a request from a user device coupled to the network for a guaranteed bandwidth rate (GBR) based on a media presentation description (MPD); determining if the requested GBR can be authorized, based on the bandwidth limit, the subscription information of the user and the network condition and usage; and transmitting a GBR response message to the user device in response to receiving the request for the GBR, the GBR response message indicating whether the GBR is authorized. After transmitting the GBR response message indicating the requested GBR is authorized, the method further includes receiving a media segment request from the user device requesting a media segment compatible with the GBR; and transmitting the requested media segment to the user device.

In yet another embodiment, there is provided an adaptive media streaming system. The system includes a user device coupled to a network and configured to request a guaranteed bandwidth rate (GBR) based on a media presentation description (MPD) and request a media segment according to an authorized GBR. A content server coupled to the network is configured to send the requested media segment to the user device, and the network is configured to provide a communications path between the user device and the content server, to authorize a GBR in response to a GBR request from the user device, and send the media segment to the user device in accordance with the authorized GBR.

Additional features and advantages of the disclosure will be set forth in the description which follows, and will become apparent from the description, or can be learned by practice of the herein disclosed principles by those skilled in the art. The features and advantages of the disclosure can be realized and obtained by means of the disclosed instrumentalities and combinations as set forth in detail herein. These and other features of the disclosure will become more fully apparent from the following description, or can be learned by the practice of the principles set forth herein.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a DASH standards-based adaptive media streaming model and system;

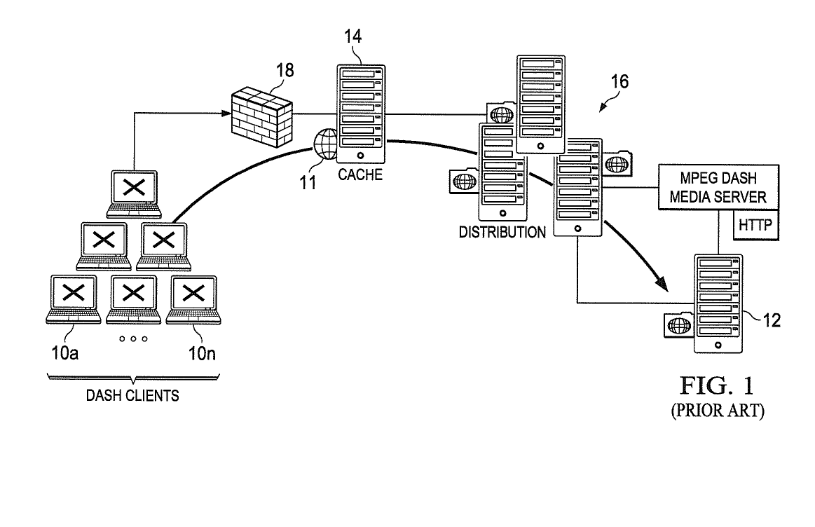

FIG. 2 illustrates conceptually the hierarchical data model described by a Media Presentation Description (MPD) within a DASH-based system;

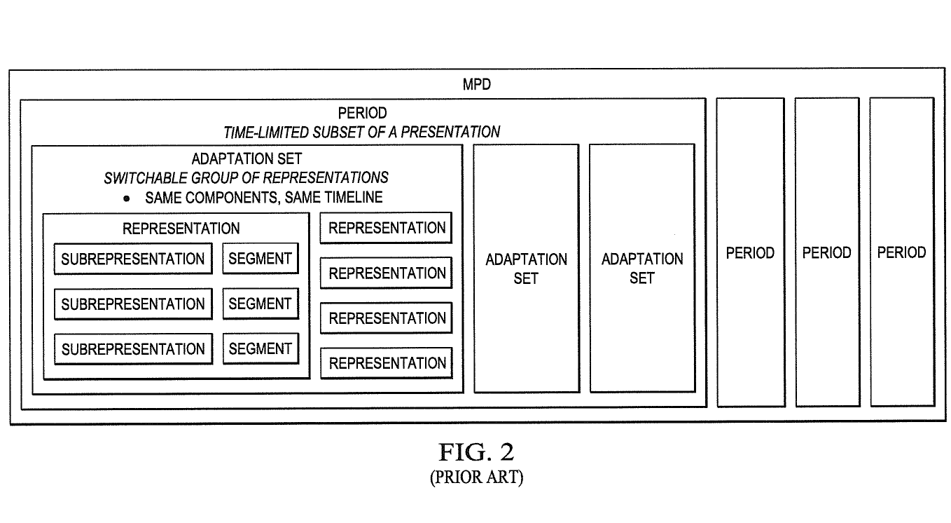

FIG. 3 is a functional block diagram illustrating a conventional DASH client and HTTP server as described according to DASH;

FIG. 4 is a block diagram of an exemplary system in accordance with the principles of the present disclosure;

FIG. 5 illustrates a flow diagram of the LTE registering process;

FIG. 6 is a flow diagram of a bandwidth negotiation and media content delivery method initiated by a DASH client in accordance with the principles of the present disclosure; and,

FIGS. 7A and 7B are overall block diagrams illustrating a UE and an eNodeB, respectively, shown in FIG. 4.

### DETAILED DESCRIPTION

The FIGURES and text below, and the various embodiments used to describe the principles of the present disclosure are by way of illustration only and are not to be construed in any way to limit the scope of the claimed invention. A person of ordinary skill in the art will readily recognize that the principles of the present disclosure may be implemented in any type of suitably arranged device or system. Specifically, while the present disclosure is described with respect to use in a cellular wireless environment, those will readily recognize other types of networks and other applications without departing from the scope of the present disclosure.

Unless defined otherwise, all technical and scientific terms used herein have the same meaning as commonly understood by those of skill in the art to which this disclosure pertains. Although any methods and materials similar or equivalent to those described herein can also be used in the practice or testing of the technology, a limited number of the exemplary methods and materials are described herein.

As will be appreciated, aspects of the present disclosure may be embodied as a method, system, or computer program product. These may take the form of an entirely hardware embodiment, an entirely software embodiment (including firmware, resident software, micro-code, etc.) or an embodiment combining software and hardware aspects that may all generally be referred to herein as a “circuit,” “module” or “system.” Field Programmable Gate Arrays (FPGAs), Application Specific Integrated Circuits (ASICs), Digital Signal Processors (DSPs) and general purpose processors alone or in combination, along with associated software, firmware and glue logic may be used to construct the present invention.

Furthermore, various aspects of the present disclosure may take the form of a computer program product on a computer-usable storage medium having computer-usable program code embodied in the medium. Any suitable computer usable or computer readable medium may be utilized. The computer-usable or computer-readable medium may be, for example but not limited to, a random access memory (RAM), a read-only memory (ROM), or an erasable programmable read-only memory (EPROM or Flash memory). Computer program code for carrying out operations of the present invention may be written in, for example but not limited to, an object oriented programming language, conventional procedural programming languages, such as the “C” programming language or other similar programming languages.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. 112 (f).

As used herein, a “module,” a “unit”, an “interface,” a “processor,” an “engine,” a “detector,” or a “receiver,” includes a general purpose, dedicated or shared processor and, typically, firmware or software modules that are executed by the processor. Depending upon implementation-specific or other considerations, the module, unit, interface, processor, engine, detector, or receiver, can be centralized or its functionality distributed and can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

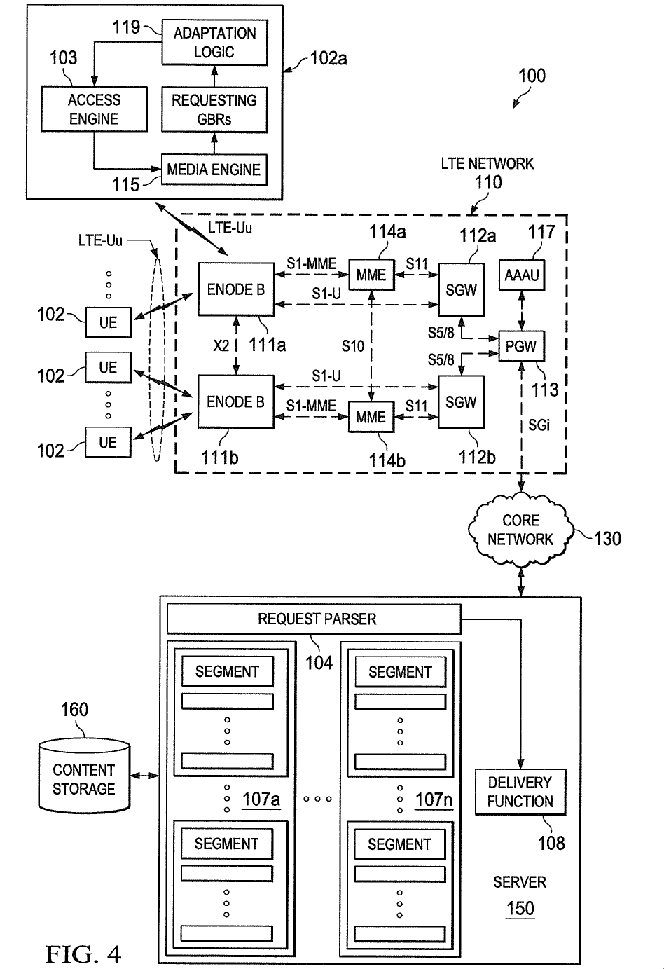

Reference is now made to FIG. 4 depicting a block diagram of an exemplary wireless communication system supporting various embodiments. While the exemplary wireless communication system is primarily discussed within the context of streaming media via a Long Term Evolution (LTE) network 110, a person of ordinary skill in the art informed by the teachings herein will realize that the teachings herein may also be suitable for use with other types of wireless networks, wireline networks or combinations of wireless and wireline networks. Further, the network 110 may function according to one or more protocols, standards and/or specifications (public or proprietary) enabling HTTP functionality.

FIG. 4 depicts an exemplary wireless communication system 100 that includes a plurality of User Equipment (UE) 102 (e.g., DASH clients 102) (and referred to hereinafter as UEs or DASH clients 102), a Long Term Evolution (LTE) network 110, a core network 130, an HTTP content server 150, and a content storage device 160. As will be appreciated, the number of each type of device in the network may be fewer and/or greater than shown, and the embodiment shown in FIG. 4 is for illustration only.

The LTE network 110 supports communications between the UEs 102 and the core network 130, such as communications for initiating content streaming sessions between the content server 150 and the UEs 102.

The UEs 102 are preferably wireless DASH client devices configured to access a wireless network, such as the LTE network 110. The UEs 102 are configured to support control signaling in support of bearer session(s) in the LTE network 110, and may be a phone, smartphone, PDA, laptop, computer, or any other wireless user device. The client devices could also be wireline connected devices with a wireline network interface if the access points are wireline based.

The structure and functionality of conventional UEs 102 (e.g, DASH clients) are well-known. These devices generally include various components such as processing units, controllers and network interfaces, which necessarily include but are not limited to, microprocessors, microcontrollers, memory devices, and/or logic circuitry, and these may be adapted to implement various algorithms and/or protocols. No additional description of the conventional components and software processes (functionality) of these devices, other than as noted herein or relevant for an understanding of the present disclosure, is provided, as these are known to those of ordinary skill in the art. It will be understood that the UEs 102 may be constructed or configured from any suitable hardware, software, firmware, or combination thereof for providing the functionality known to those of ordinary skill in the art. The UEs 102 will include additional functionality as described below in accordance with one or more embodiments.

Configuration and operation of the LTE network 110 are well understood. For illustrative but not limiting purposes, the exemplary LTE network 110 includes eNodeBs 111a and 111b (collectively, eNodeBs 111), Serving Gateways (SGWs) 112a and 112b (collectively, SGWs 112), a Packet Data Network Gateway (PGW) 113, Mobility Management Entities (MMEs) 114a and 114b (collectively, MMEs 114) and an authentication unit (AAAU) 117. The eNodeBs 111 provide a wireless access interface for UEs 102. The SGWs 112, PGW 113, MMEs 114 and AAAU 117, as well as other possible components which have been omitted for purposes of clarity, are configured to provide an Evolved Packet Core (EPC) network supporting end-to-end service delivery using IP.

The structure and functionality of the eNodeBs, SGWs, PGWs, MMEs and AAAU and other network components are generally well-known. These devices will typically include various components such as processing units, controllers and network interfaces, which necessarily include but are not limited to, microprocessors, microcontrollers, memory devices, and/or logic circuitry, and these may be adapted to implement various algorithms and/or protocols. No additional description of the conventional components and software processes (functionality) of these devices, other than as noted herein or relevant for an understanding of the present disclosure, is provided, as these are known to those of ordinary skill in the art.

As depicted in FIG. 4, each eNodeB 111 supports a respective plurality of UEs 102. The communication between the eNodeBs 111 and the UEs 102 is supported using LTE-Uu interfaces associated with each of the UEs 102. The SGW 112a supports communications for the eNodeB 111a while the SGW 112b supports communications for the eNodeB 111b. The communication between the SGWs 112 and the eNodeBs 111 is supported using respective S1-u interfaces. The S1-u interfaces support per-bearer user plane tunneling and inter-eNodeB path switching during handover.

The PGW 113 supports communications for the SGWs 112. The communication between PGW 113 and SGWs 112 is supported using respective S5/S8 interfaces. The S5 interfaces provide functions such as user plane tunneling and tunnel management for communications between PGW 113 and SGWs 112, SGW relocation due to UE mobility, and the like. The S8 interfaces, which may be Public Land Mobile Network (PLMN) variants of the S5 interfaces, provide inter-PLMN interfaces providing user and control plane connectivity between the SGW in the Visitor PLMN (VPLMN) and the PGW in the Home PLMN (HPLMN). The PGW 113 facilitates communications between LTE network 110 and core network 130 via a SGi interface.

The MMEs 114 provide mobility management functions in support of mobility of UEs 102. The MME 114a supports the eNodeB 111a while the MME 114b supports the eNodeB 111b. The communication between the MMEs 114 and the eNodeBs 111 is supported using respective S1-MME interfaces, which provide control plane protocols for communication between the MMEs 114 and the eNodeBs 111.

A Policy and Charging Rules Function (PCRF) node (not shown but which may be integrated with the AAAU 117) provides dynamic management capabilities by which the service provider may manage rules related to services provided via LTE network 110 and rules related to charging for services provided via LTE network 110.

As appreciated, the network 110 is exemplary and other suitable configurations or networks may be utilized.

The core network 130 may include one or more packet data networks (e.g., IP-based) via which the UEs 102 may access content, services, and the like. Although the core network 130 is shown as a separate network from the LTE network 110, it will be understood that the specific networks 110 and 130 can also be collectively referred to as the network.

The HTTP server 150 is connected to the core network 130 and configured to support streaming content sessions as discussed herein. The HTTP server 150 may store content locally or remotely via, illustratively, a content storage device 160 in communication with the server 150.

The DASH client 102a is shown including an access engine 103 coupled to a media engine 115 and adaptation logic 119 which are described in more detail herein below. The DASH client 102 transmits HTTP requests over the LTE network 110 and IP network 130 to a request parser engine 104 in the server 150. A delivery function engine 108 within the content server 150 transmits HTTP responses to the DASH client 102 (e.g., media presentation description (MPD) files 107a-107n containing media segment information such as the length of time, file size, play starting time, file storage site, media type and resolution, as well as the media content segments). In other embodiments, it is possible that MPDs may be received by the UE 102a from a network device other than the content server 150.

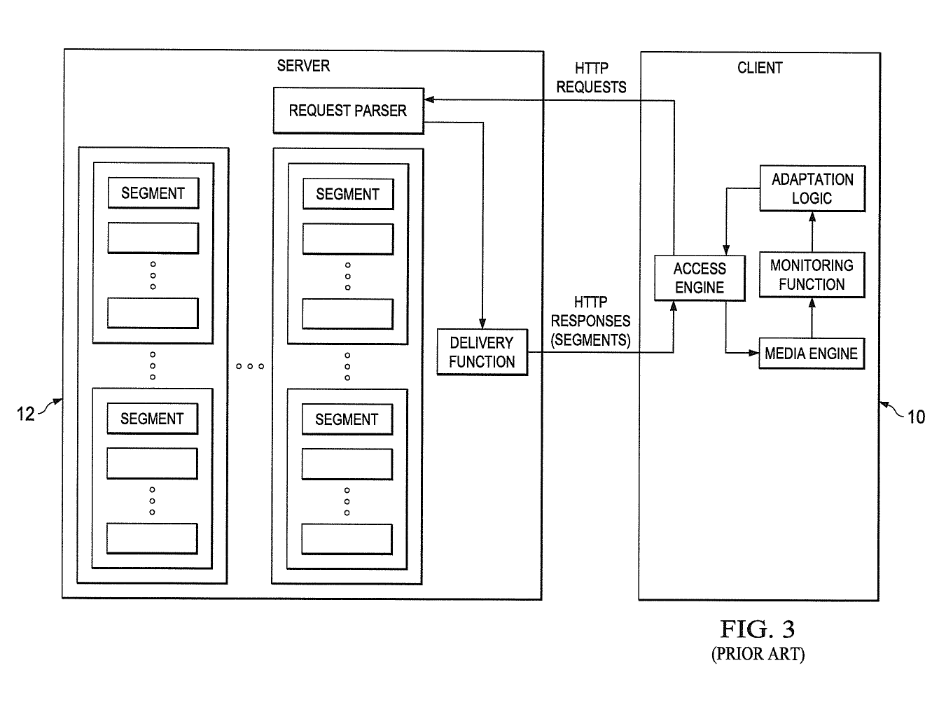

One difference between a conventional DASH client 10 (FIG. 3) and the DASH client 102a (FIG. 4) of the present disclosure is that the DASH client 102a includes functionality for generating and transmitting a guaranteed bit rate (GBR) request to the network and/or content server 150.

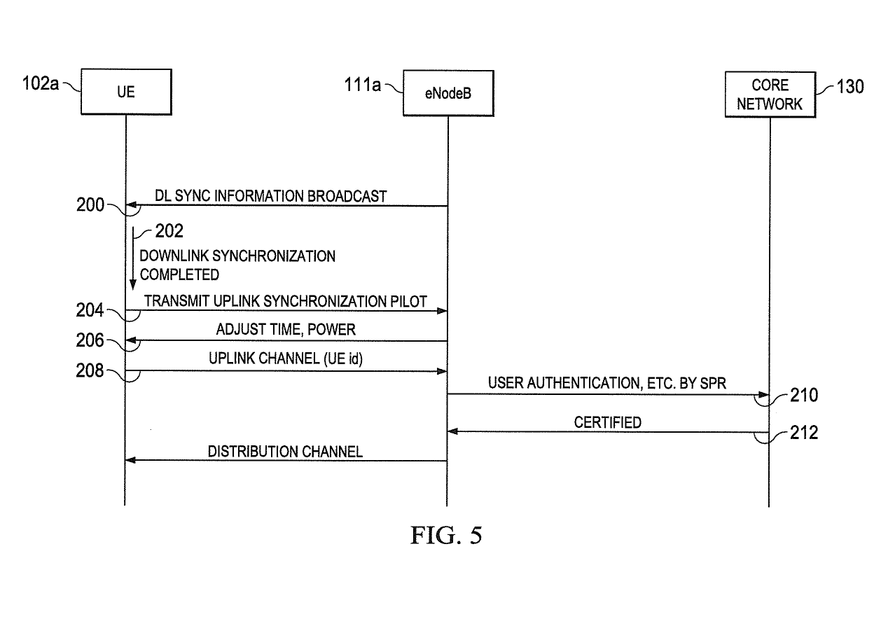

Now turning to FIG. 5, there is illustrated a network registering process (using eNodeB 111a as an example) for registering the UE 102 with the network 110. The eNodeB 111a broadcasts downlink (DL) wireless information to the UE 102 (step 200) and the UE 102 completes DL synchronization with the eNodeB 111a (step 202). The UE transmits an uplink (UL) synchronization pilot signal to the eNodeB 111a (step 204) and, in response, the eNodeB 111a transmits time and power adjustments to the UE 102 (step 206). The UE 102 then sends its UE identification to the eNodeB 111a for identification purposes (step 208), and the eNodeB 11a sends a user authentication request to the core network 130 using the subscription profile repository (SPR) (step 210). Upon certification by the core network 130, an eNodeB certification of the UE (user) credentials is received at the eNodeB 111a (step 212).

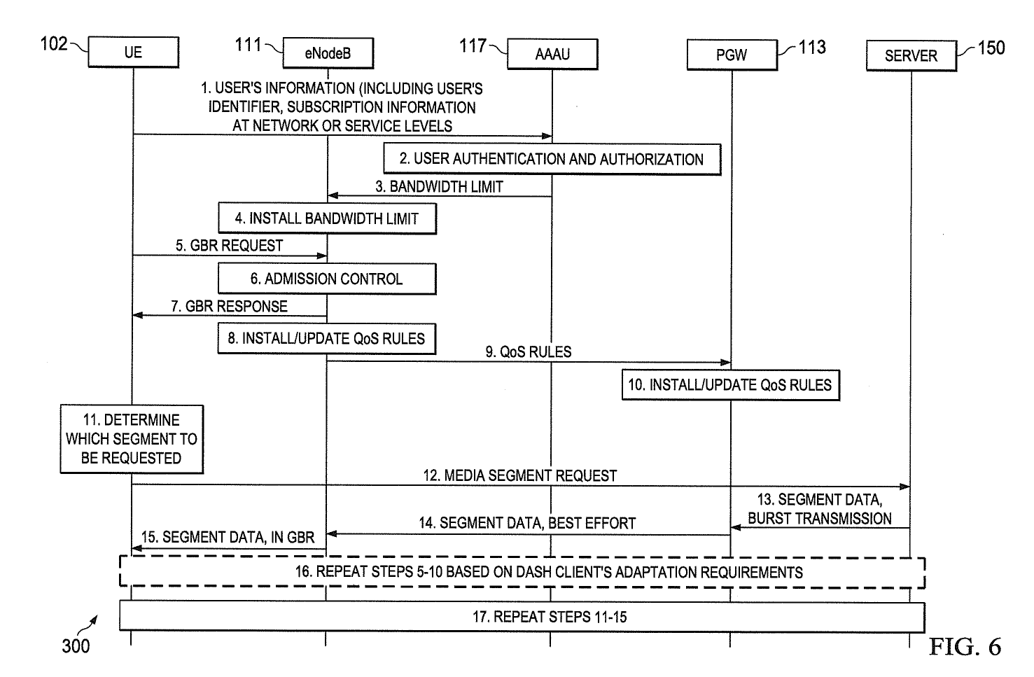

Now turning to FIG. 6, there is illustrated a flow diagram or process 300 for the DASH client 102a initiated bandwidth negotiation and media content delivery method with the content server 150 in accordance with the principles of the present disclosure.

The DASH client 102 transmits user information, such as the user's identification and subscription information, to the network authentication unit (AAAU) 117 (step 1). As will be appreciated, this information may be defined at the level of the network 130 and/or the content server 150. The AAAU 117 authenticates the DASH client 102 and determines or identifies a maximum allowed bandwidth allocated/assigned to that DASH client 102 (step 2). Generally, the user of the DASH client 102 will have a subscription service with a network operator and/or service provider for a specified quality of service (QoS) or maximum allowed bandwidth (or bit rate). In addition, a minimum bandwidth may also be allocated/assigned to the user.

The maximum allowed bandwidth information may be retrieved from memory within the AAAU 117 or from another device or node in the network. After authentication and authorization, the AAAU 117 transmits this maximum allowed bandwidth information (and/or minimum bandwidth information) to the eNodeB 111a servicing the DASH client 102 (step 3). Upon receipt of the bandwidth limit, the eNodeB 111 determines/assigns/programs a guaranteed bandwidth rate or bit rate (GBR) for the DASH client 102 (step 4) that it can provide. As a result, the eNodeB 111 controls and enforces the guaranteed bandwidth or bit rate (GBR) for the DASH client 102. In most embodiments, the GBR does not exceed the maximum allowed bandwidth. In some other embodiments, the GBR can take the form of a minimum bit rate that the network can provide the user based on the user's subscription information as well as existing network conditions and usages. With this minimum bit rate, the client can be sure that a lower bound of bandwidth is guaranteed by the network, and it can make requests for media segments of bit rates not necessarily lower than the minimum bit rate.

At a point in the process, the DASH client 102 sends a guaranteed bandwidth/bit rate (GBR) request to the eNodeB 111 based on its service information (step 5). This GBR request includes information identifying a particular GBR (one or multiple alternatives) that the DASH client 102 desires/requests. The eNodeB 111 executes admission control based on the DASH client's bandwidth limit and the current available resources of the eNodeB 111 (and/or within the network) (step 6) and transmits to the DASH client 102 a GBR response that includes a determined/assigned/acceptable GBR (step 7). Though not shown, if the GBR requested by the DASH client 102 is greater than the maximum bandwidth allowed to the DASH client 102 or cannot be fulfilled by the network, then the GBR response includes rejection information. In one embodiment, the rejection information may include a suggested or recommended GBR that is lower than the requested one and/or one for which the network can provide. Depending on the GBR response, the DASH client 102 may then transmit one or more further GBR request(s) with a lower or higher GBR, or choose to accept the GBR suggested in the GBR response, and so on.

In another embodiment, the GBR request may not specify a particular requested GBR. In such case, the GBR request can be considered a “best possible” or “arbitrary” GBR request with no specific GBR being requested, and the GBR request is merely a request for some GBR (but no specific identifiable GBR) that the network is able to provide, for instance, for the purpose of shortening the GBR negotiation process with the underlying network by minimizing the number of negotiation iterations. The eNodeB 111 then determines what GBR it can provide, and sends the GBR response with the determined/assigned/acceptable GBR. In particular, this GBR might be the best GBR the eNodeB (or network) can provide.

Once the GBR for the DASH client 102 has been negotiated and assigned, the eNodeB 111 and the PGW 113 separately install or update their quality of service (QoS) rules (e.g., error rates, bandwidth, minimum bit rate, throughput, transmission delay, availability, jitter, etc.) applicable to the DASH client 102 (for the subsequent communications).

After receiving the GBR, the adaptation logic module or component 119 in the DASH client 102 considers this information in determining which media segment to select/request from the server 150 (step 11) from among a plurality of media segments that are available to be selected (as identified in the MPD). In one embodiment, the media segment selected can be a media segment having a bitrate/bandwidth closest (e.g., less than or slightly more than) to the GBR. Other factors and/or information may be utilized by the DASH client 102 when selecting which media segment to request. Once determined, the DASH client 102 requests the selected media segment from the server 150 (step 12).

In response to the media segment request, the server 150 transmits the media segment data to the PGW 113 (step 13). This transmission may be via a burst-type transmission. The PGW 113 then transmits the media segment data to the eNodeB 111a using its best effort (step 14), which is usually at a bit rate that is greater than the GBR. The eNodeB 111a enforces the GBR and transmits the media segment data to the DASH client 102 in accordance with this guarantee (it may be higher depending on resources availability) (step 15).

The DASH client 102 may repeat the GBR negotiation process (steps 5-10) if, for example, the client wants to request a media segment with a higher bitrate or the subsequent segment differs significantly in bitrate from previous one if variable bit rate (VBR) coded (shown as step 16). Similarly, the DASH client 102 may repeat the media segment request and receipt process (steps 11-15) for a new media segment.

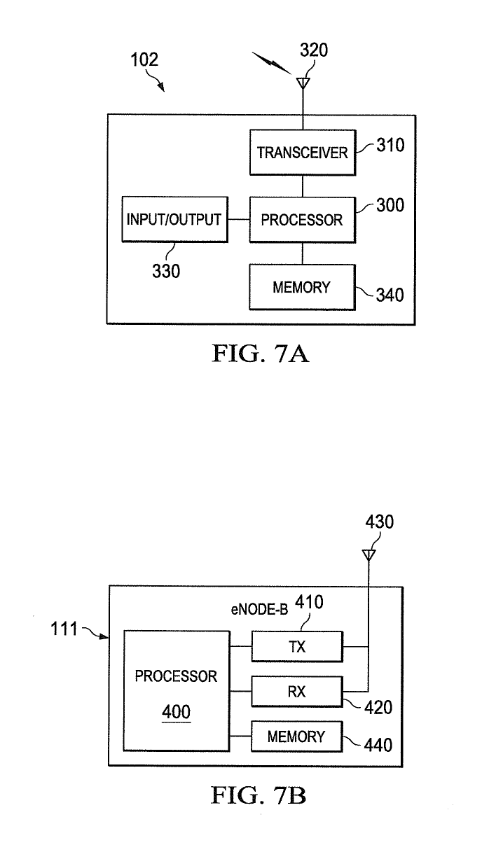

Turning now to FIG. 7A, there is shown an overall block diagram of an example UE 102. The UEs 102 represent devices utilized by a user or subscriber during communication sessions over/within the system 100. Each UE 102 typically includes a processor, memory, a transceiver and an antenna and may be constructed or configured from any suitable hardware, software, firmware, or combination thereof for transmitting or receiving information over a network. These devices may further include an input/output device having a microphone and speaker to capture and play audio information, as well as a camera and/or a display to capture/display video information. As an example, the UE 102 may be a telephone, videophone, computer, personal digital assistant, mobile phone, smartphone, tablet, or the like, etc.

In the illustrated embodiment, the UE 102 includes a processor 300, a transceiver 310, an antenna element 320, one or more input/output devices 330 (e.g., speaker/microphone, keypad, display/touchpad) and memory 340. The UE 102 may include one or more other components, devices, or functionalities (not shown). Herein, the UEs 102 include the necessary functionality for operating as a DASH client.

The processor 200 may be a general purpose, special purpose or digital signal processor, and may be a plurality of processors or combination of such processors. The processor 300 includes functionality to perform signal coding, data processing, power control, input/output processing, and/or any other functionality enabling the UE 102 to operate in the system 100. The processor 300 is coupled to the transceiver 310 which is coupled to the antenna element 320. It will be understood that the processor 300 and the transceiver 310 may be separate components or integrated together. Similarly, the antenna element 320 may be a single element or a number of elements (multiple antennas or elements).

The transceiver 310 is configured to modulate the data or signals for transmission by the antenna 320 and demodulate the data or signals received by the antenna 320.

The processor 300 is coupled to the one or more input/output devices 330 (including ports or busses) operable for inputting/outputting user data. In addition, the processor 300 is coupled to memory 330 operable for storing and retrieving data. Any suitable type of memory storage device may be included, such as random-access memory (RAM), read-only memory (ROM), hard disk, subscriber identity module (SIM) card, a memory stick, a secure digital (SD) memory card, and the like.

Other elements or devices that might be included within in the UE 102 will not be described herein, unless necessary or relevant to an understanding of the present disclosure. Though illustrated as a wireless device, the UE 102 may further include a network interface configured for wireline network connectivity to a wireline network access point.

Now turning to FIG. 7B, there is a block diagram of an example eNodeB 111 having a processor 400, a transmitter 410, a receiver 420, an antenna 430 and memory 440. Additional suitable components or devices may be included (but not shown). The antenna 430 may include one or more antennas and/or one or more elements (multiple antennas or elements). The configuration and operation of the eNodeB 111 is readily known and understood by those of ordinary skill in the art, and no further description or explanation of its structure or operation is provided herein unless necessary for an understanding of the present disclosure or except for new or additional functionality described above. Though illustrated as a wireless device, in an embodiment in which the UE is wireline based, the eNodeB 111 may be a wireline-based network access point (such as a device operated by a network provider) and would include a network interface configured for wireline network connectivity to the UE 102.

In operation, the principles of the present disclosure enables a wireless network operator to restrict bandwidth/bitrate while at the same time ensure that a basic content quality is maintained for its regular users and some higher quality for premium users. For this purpose, the operator will assign certain bitrate quality levels to different users on their HTTP connections carrying DASH-content.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of non-volatile medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for requesting media content in a dynamic adaptive media streaming system over a transmission network, according to a media presentation description (MPD) comprising information identifying a plurality of media segments, the method comprising:
generating and transmitting, by a user device, a request for a guaranteed bitrate/bandwidth rate (GBR) to the network,
receiving, at the user device, a response authorizing a GBR for the user device;
selecting, at the user device, based on the authorized GBR and the MPD information, at least one of the plurality of media segments;
generating and transmitting a request to a content server identifying the selected at least one of the plurality of media segments; and
receiving from the content server the selected at least one of the plurality of media segments.

2. The method in accordance with claim 1 wherein selecting at least one of the plurality of segments comprises:
selecting a media segment having a bitrate closest to the authorized GBR.

3. The method in accordance with claim 1 further comprising:
playing the received media segment at the user device.

4. The method in accordance with claim 1 wherein the authorized GBR is a minimum bitrate/bandwidth rate.

5. The method in accordance with claim 1 wherein the request for the GBR does not identify a specific GBR.

6. The method in accordance with claim 1 wherein the request for the GBR requests a specific GBR, and the authorized GBR is higher than the requested specific GBR.

7. The method in accordance with claim 5 wherein the request for the GBR requests a specific GBR, and the authorized GBR is lower than the requested specific GBR.

8. An adaptive media streaming method in a network, the method comprising:
authenticating and authorizing a bandwidth limit of a user based on subscription information of the user in a network;
receiving a request from a user device coupled to the network for a guaranteed bandwidth rate (GBR) based on a media presentation description (MPD);
determining if the requested GBR can be authorized, based on the bandwidth limit, the subscription information of the user and the network condition and usage;
transmitting a GBR response message to the user device in response to receiving the request for the GBR, the GBR response message indicating whether the GBR is authorized;
after transmitting the GBR response message indicating the requested GBR is authorized, receiving a media segment request from the user device requesting a media segment compatible with the GBR; and
transmitting the requested media segment to the user device.

9. The method in accordance with claim 8 wherein the subscription information is configured at least at one of the following levels: a network operator level and a media service provider level.

10. The method in accordance with claim 8 wherein the GBR response message indicates the GBR is not authorized when the request for the GBR exceeds the user bandwidth limit.

11. The method in accordance with claim 8 wherein the user device is configured as a Dynamic Adaptive Streaming over Hypertext Transfer Protocol (DASH) client.

12. The method in accordance with claim 11 wherein an adaptation strategy of the DASH client is based on the authorized GBR from the network instead of its own bandwidth detection.

13. The method in accordance with claim 11 wherein the network is a long-term evolution (LTE) network comprising an eNodeB configured to transmit the requested media segment to the user device in accordance with the authorized GBR.

14. The method in accordance with claim 8 wherein the authorized GBR is a minimum bitrate/bandwidth rate.

15. An adaptive media streaming system, comprising:
a user device coupled to a network and configured to request a guaranteed bandwidth rate (GBR) based on a media presentation description (MPD) and request a media segment according to an authorized GBR;
a content server coupled to the network and configured to send the requested media segment to the user device; and,
wherein the network is configured to provide a communications path between the user device and the content server, to authorize a GBR in response to a GBR request from the user device, and send the media segment to the user device in accordance with the authorized GBR.

16. The system in accordance with claim 15 wherein the network is further configured to reject the request for the GBR when the requested GBR exceeds a predetermined bandwidth limit associated with the user device.

17. The system in accordance with claim 15 wherein the user device is configured as a Dynamic Adaptive Streaming over Hypertext Transfer Protocol (DASH) client.

18. The system in accordance with claim 16 wherein an adaptation strategy of the DASH client is based on guaranteed bandwidth from the network instead of its own bandwidth detection.

19. The system in accordance with claim 15 wherein the network is a long-term evolution (LTE) network having an eNodeB configured to transmit the requested media segment to the user device in accordance with the GBR.

20. The system in accordance with claim 15 wherein the authorized GBR is a minimum bitrate/bandwidth rate.
